(19) United States
(12) Patent Application Publication
(10) Pub. No.: US 2025/0109909 A1
(43) Pub. Date: Apr. 3, 2025

(54) SAGGAR

(71) Applicant: NGK INSULATORS, LTD., Nagoya-Shi (JP)

(72) Inventors: Michiro AOKI, Obu-Shi (JP); Takeshi KOMAKI, Nagoya-Shi (JP)

(73) Assignee: NGK INSULATORS, LTD., Nagoya-Shi (JP)

(21) Appl. No.: 18/675,495

(22) Filed: May 28, 2024

(30) Foreign Application Priority Data
Sep. 28, 2023 (JP) 2023-168622

(51) Int. Cl. F27D 5/00; H01M 4/02; H01M 4/04

(52) U.S. Cl. CPC F27D 5/0012; H01M 4/0471; H01M 2004/028

(57) ABSTRACT

A saggar may include: a ceramic part of ceramic with a box shape, the ceramic part including an outer bottom surface and an outer side wall; and a metal part having a box shape, the metal part including an inner bottom surface and an inner side wall, the metal part being removably disposed inside the ceramic part, wherein when the metal part is inside the ceramic part at a room temperature, a clearance is defined between the outer and inner side walls, the outer side wall includes at least a pair of recesses, in a plan view of the metal part, the pair of recesses is at positions facing each other across a center of the metal part, the metal part includes at least a pair of flanges, and when the metal part is inside the ceramic part, the pair of flanges is located within the pair of recesses.

### REFERENCE TO RELATED APPLICATION

The present application claims priority to Japanese Patent Application No. 2023-168622 filed on Sep. 28, 2023, the entire contents of which are incorporated herein by reference.

### TECHNICAL FIELD

The art disclosed herein relates to a saggar used for thermally treating powder of a lithium positive electrode material.

### BACKGROUND ART

Heat treatment using a heat treatment furnace (e.g., roller hearth kiln) to thermally treat powder, which is a raw material of a lithium positive electrode material, may be performed. When the powder of the lithium positive electrode material (hereafter, may simply be referred to as “powder”) is thermally treated, the powder is placed in a saggar, and the saggar accommodating the powder is conveyed through the heat treatment furnace. Typically, the powder is placed in the saggar constituted of ceramic having high heat resistance, because a temperature for thermally treating the lithium positive electrode material is high. An art configured to thermally treat the powder by using a saggar constituted of metal has been, however, developed in recent years. Because the saggar constituted of metal has a high heat conductivity, the powder accommodated in the saggar can be effectively heated during the heat treatment in the heat treatment furnace. For example, an example of a saggar constituted of metal is described in Japanese Patent Application Publication No. 2015-137814.

### SUMMARY

In order to improve productivity in thermally treating powder, plural saggars may be used in a manner of being stacked in an up-down direction in the heat treatment in the heat treatment furnace. However, there was a problem that it is difficult to stack plural saggars constituted of metal in the up-down direction because they are less durable to vertical load.

The present disclosure provides an art configured to thermally treat powder of a lithium positive electrode material effectively.

In a first aspect of the art disclosed herein, a saggar for thermally treating powder of a lithium positive electrode material may be disclosed, the saggar being configured to accommodate the powder and to be disposed in a heat treatment furnace for heat treatment of the powder, in which the saggar may comprise: a ceramic part constituted of ceramic and having a box shape, the ceramic part comprising an outer bottom surface and an outer side wall projecting upward from the outer bottom surface, the ceramic part being open at its top portion; and a metal part having a box shape, the metal part comprising an inner bottom surface and an inner side wall projecting upward from the inner bottom surface, the metal part being open at its top portion and being removably disposed inside the ceramic part. When the metal part is disposed inside the ceramic part at a room temperature, a clearance may be defined between the outer side wall and the inner side wall. The outer side wall may comprise at least a pair of recesses recessed from an upper end toward a lower end of the outer side wall. In a plan view of the metal part, the pair of recesses may be disposed at positions facing each other across a center of the metal part. The metal part may comprise at least a pair of flanges extending outward from an upper end of the inner side wall. When the metal part is disposed inside the ceramic part, the pair of flanges may be located within the pair of recesses.

### BRIEF DESCRIPTION OF DRAWINGS

FIG. 1 illustrates a top view of a saggar according to an embodiment.

FIG. 2 illustrates a side view of the saggar according to the embodiment.

FIG. 3 illustrates a cross-sectional view taken along III-III in FIG. 1.

FIG. 4 illustrates a diagram for explaining dimensions of respective parts of the saggar according to the embodiment.

FIG. 5 illustrates a diagram showing effects upon a saggar and powder when the powder is thermally treated using saggars of examples 1 and 2 and comparative examples 1 to 5.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved saggars, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a first aspect of the technology disclosed herein, a saggar for thermally treating powder of a lithium positive electrode material, the saggar being configured to accommodate the powder and to be disposed in a heat treatment furnace for heat treatment of the powder, the saggar may comprise: a ceramic part constituted of ceramic and having a box shape, the ceramic part comprising an outer bottom surface and an outer side wall projecting upward from the outer bottom surface, the ceramic part being open at its top portion; and a metal part having a box shape, the metal part comprising an inner bottom surface and an inner side wall projecting upward from the inner bottom surface, the metal part being open at its top portion and being removably disposed inside the ceramic part. When the metal part is disposed inside the ceramic part at a room temperature, a clearance may be defined between the outer side wall and the inner side wall. The outer side wall may comprise at least a pair of recesses recessed from an upper end toward a lower end of the outer side wall. In a plan view of the metal part, the pair of recesses may be disposed at positions facing each other across a center of the metal part. The metal part may comprise at least a pair of flanges extending outward from an upper end of the inner side wall. When the metal part is disposed inside the ceramic part, the pair of flanges may be located within the pair of recesses.

In the above-mentioned saggar, because the metal part is disposed inside the ceramic part, the powder comes into contact with the metal part when the powder is accommodated in the saggar. Due to this, the powder can be effectively heated. Further, because the ceramic part is disposed outside the metal part, durability against the vertical load is improved since the vertical load is received at the ceramic part. Due to this, a plurality of the saggars can be stacked in the up-down direction. These features can improve productivity. Also, the metal part is removably disposed inside the ceramic part, and the flanges of the metal part are located within the recesses of the ceramic part. When the powder after the heat treatment is to be collected from the saggar, the saggar can be turned upside down so that the powder can be dropped to be collected. If for example the metal part is adhered to the ceramic part, although it is possible to prevent the metal part from falling when the saggar is turned upside down, it becomes difficult for the metal part, which is reusable, to be removed from the saggar when the saggar is to be disposed of. Because the flanges of the metal part are positioned within the recesses of the ceramic part, the metal part can be prevented from falling as long as the saggar is turned upside down with the saggar being held at positions where the flanges are located. Due to this, because the flanges of the metal part are located within the recesses of the ceramic part, even if the metal part is not adhered to the ceramic part, the saggar can be easily turned upside down in a way that the metal part does not fall. Due to this, the powder can easily be collected, and also the metal part can be easily removed for re-use of the meal part. Also, the metal has a higher coefficient of thermal expansion than the ceramic, as a result of which the metal expands more easily than the ceramic when the saggar is placed under a heat treatment condition (e.g., when arranged in the heat treatment furnace). By the clearance being defined between the side surface of the ceramic part and the side surface of the metal part, it is possible to avoid that the ceramic part is broken due to the metal part even when the metal part located inside the ceramic part expands.

In a second aspect of the technology disclosed herein according to the first aspect, the metal part may comprise at least a surface constituted of metal containing aluminum. According to such feature, the metal containing aluminum is disposed in the surface of the metal part. Due to this, an alumina coating film is formed on the surface of the metal part when the saggar is placed under the heat treatment condition (e.g., when arranged in the heat treatment furnace). Due to this, the metal part can be suppressed from being oxidized by the powder in the saggar during heat treatment.

In a third aspect of the technology disclosed herein according to the first or second aspect, the metal part may be constituted of a nickel-based alloy containing aluminum. According to such feature, an alumina coating film is formed on the surface of the metal part when the saggar is placed under the heat treatment condition (e.g., when arranged in the heat treatment furnace). Due to this, the metal part can be suppressed from being oxidized by the powder in the saggar during the heat treatment.

In a fourth aspect of the technology disclosed herein according to any one of the first to third aspects, the ceramic part and the metal part may have a rectangular shape in a plan view. The outer side wall may comprise a pair of first outer side walls and a pair of second outer side walls orthogonal to the pair of first outer side walls. The inner side wall may comprise a pair of first inner side walls and a pair of second inner side walls orthogonal to the pair of first inner side walls. When the metal part is disposed inside the ceramic part, the pair of first outer side walls may be parallel to the pair of first inner side walls and the pair of second outer side walls may be parallel to the pair of second inner side walls. When a coefficient of thermal expansion of the ceramic part is a, a coefficient of thermal expansion of the metal part is b, and a maximum temperature during heat treatment of the powder in the saggar is T, when an inner dimension between the first outer side walls is L1o and an outer dimension between the first inner side walls is L1i, a clearance defined between the first outer side walls and the first inner side walls may be larger than (L1i×b×T)−(L1o×a×T), and when an inner dimension between the second outer side walls is L2o and an outer dimension between the second inner side walls is L2i, a clearance defined between the second outer side walls and the second inner side walls may be larger than (L2i×b×T)−(L2o×a×T). According to such feature, even if the metal part expands when the saggar is placed under the heat treatment condition (e.g., when arranged in the heat treatment furnace), the metal part can fit into the clearance. Due to this, the ceramic part can be suitably avoided from being broken due to the metal part.

In a fifth aspect of the technology disclosed herein according to any one of the first to fourth aspects, when the metal part is disposed inside the ceramic part, the inner bottom surface may be in contact with the outer bottom surface. According to such feature, the metal part can be avoided from being deformed due to weight of the powder accommodated in the metal part.

In a sixth aspect of the technology disclosed herein according to any one of the first to fifth aspects, wherein when the metal part is disposed inside the ceramic part, upper surfaces of the flanges may be located below the upper end of the outer side wall. According to such feature, the recesses can be suppressed from being blocked by the inner side wall. Due to this, gas generated from the powder accommodated in the saggar during the heat treatment can be discharged out of the recesses.

### EMBODIMENTS

A saggar 10 will be described with reference to drawings. The saggar 10 is configured to accommodate a treatment article, which is powder. In the present embodiment, the treatment article accommodated in the saggar 10 is powder of a lithium positive electrode material (hereafter may simply be referred to as “powder”). A heat treatment furnace configured to thermally treat the powder (e.g., roller hearth kiln) is configured to convey the saggar 10 from an entrance to an exit. The saggar 10 is conveyed inside the heat treatment furnace with the powder accommodated in the saggar 10.

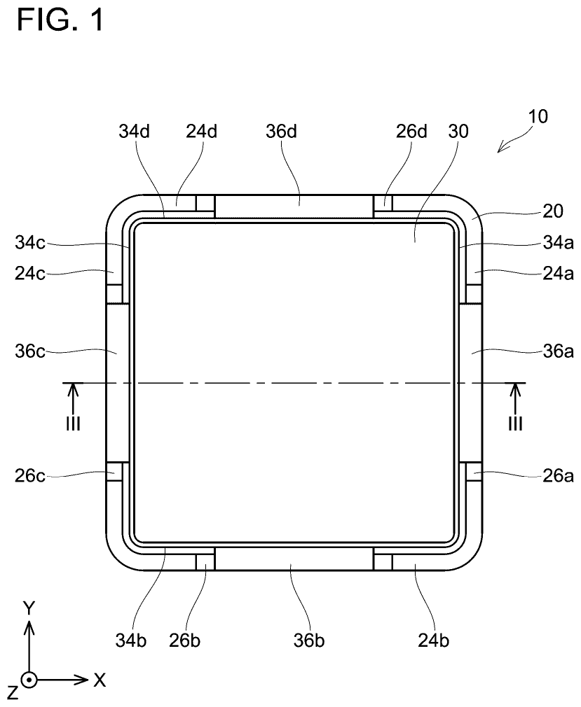

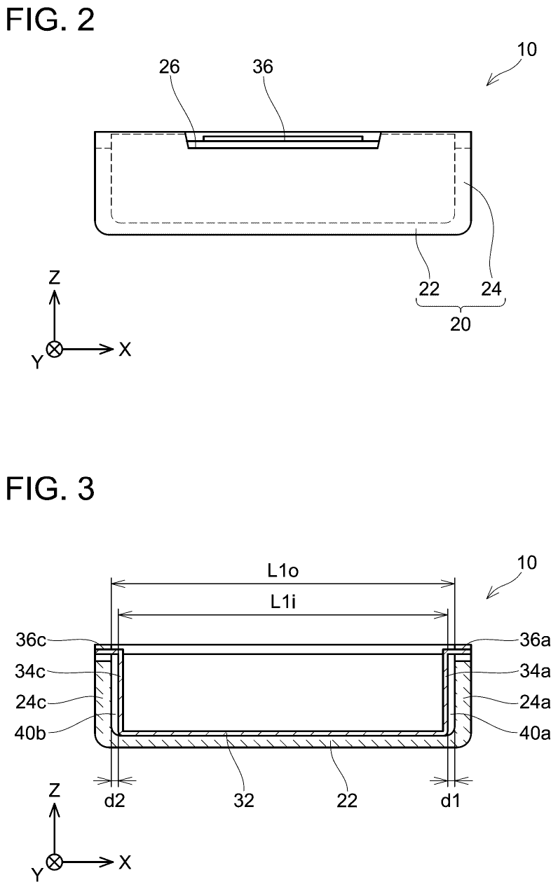

As shown in FIGS. 1 to 3, the saggar 10 has a box shape and is rectangular in a top view. In the present embodiment, the saggar 10 has a substantially square shape in the top view. The saggar 10 comprises a ceramic part 20 and a metal part 30. The metal part 30 is disposed removably inside the ceramic part 20.

The ceramic part 20 has a box shape and is constituted of ceramic. The ceramic part 20 has a substantially square shape in the top view of the saggar 10. The ceramic part 20 comprises an outer bottom surface 22 and an outer side wall 24.

The outer bottom surface 22 is planar in a substantially square shape. The outer side wall 24 is disposed along an outer periphery of the outer bottom surface 22 and projects upward from the outer bottom surface 22. The outer side wall 24 comprises four planar side surfaces (hereafter, may be referred to as a first outer side wall 24a to a fourth outer side wall 24d). The first outer side wall 24a to the fourth outer side wall 24d are disposed on respective sides of the outer periphery of the outer bottom surface 22. The first outer side wall 24a and the third outer side wall 24c are disposed to face each other, and the second outer side wall 24b and the fourth outer side wall 24d are disposed to face each other. The first outer side wall 24a to the fourth outer side wall 24d have dimensions in a height direction that substantially coincide each other.

The first outer side wall 24a to the fourth outer side wall 24d have respective recesses 26a to 26d defined therein. The recess 26a is defined in the first outer side wall 24a. The recess 26a is recessed downward from an upper end of the first outer side wall 24a. The recess 26a is disposed around a center of the first outer side wall 24a. The recesses 26b to 26d are respectively defined in the second outer side wall 24b to the fourth outer side wall 24d, and have a same shape as the recess 26a. Hereafter, when the recesses 26a to 26d do not need to be distinguished from each other, each of the recesses 26a to 26d may be referred to as the “recess 26” without the alphabet index. By the recesses 26 being disposed in the outer side wall 24, when a plurality of the saggars 10 is thermally treated with the saggars 10 stacked in the up-down direction, gas generated from the powder accommodated in each saggar 10 can be discharged from the recesses 26. Further, flanges 36 to be described later are arranged in the recesses 26.

The metal part 30 has a box shape and is constituted of metal. In the present embodiment, the metal part 30 is constituted of stainless steel and its surface is coated with aluminum (aluminized). A thickness of the metal part 30 is substantially the same throughout its entirety and in the present embodiment is approximately 2 mm. The metal part 30 has a substantially square shape in the top view of the saggar 10. The metal part 30 comprises an inner bottom surface 32, an inner side wall 34, and the flanges 36a to 36d.

The inner bottom surface 32 is planar in a substantially square shape. The inner bottom surface 32 is made smaller than the outer bottom surface 22. When the metal part 30 is disposed inside the ceramic part 20, the inner bottom surface 32 is mounted on the outer bottom surface 22 and a lower side of the inner bottom surface 32 is in contact with an upper side of the outer bottom surface 22.

The inner side wall 34 is disposed along an outer periphery of the inner bottom surface 32 and projects upward from the inner bottom surface 32. The inner side wall 34 comprises four planar side surfaces (hereafter, may be referred to as a first inner side wall 34a to a fourth inner side wall 34d). The first inner side wall 34a to the fourth inner side wall 34d are disposed on respective sides of the outer periphery of the inner bottom surface 32. The first inner side wall 34a and the third inner side wall 34c are disposed to face each other, and the second inner side wall 34b and the fourth inner side wall 34d are disposed to face each other. The first inner side wall 34a to the fourth inner side wall 34d have dimensions in the height direction that substantially coincide each other. Also, the height-wise dimensions of the first inner side wall 34a to the fourth inner side wall 34d are made smaller than the height-wise dimensions of the first outer side wall 24a to the fourth outer side wall 24d. Specifically, when the metal part 30 is disposed inside the ceramic part 20, upper ends of the first inner side wall 34a to the fourth inner side wall 34d are located between lower ends of the recesses 26 and upper ends of the first outer side wall 24a to the fourth outer side wall 24d, and are preferably located in proximity to the lower ends of the recesses 26. By the upper ends of the first inner side wall 34a to the fourth inner side wall 34d being located in proximity to the lower ends of the recesses 26, the recesses 26 can be suppressed from being blocked by the first inner side wall 34a to the fourth inner side wall 34d.

The flanges 36a to 36d are respectively connected to the first inner side wall 34a to the fourth inner side wall 34d. The flange 36a is planar and disposed perpendicular to the first inner side wall 34a. The flange 36a extends outward of the saggar 10 from the upper end of the first inner side wall 34a. The flange 36a is disposed around a center of the first inner side wall 34a. The flange 36a has a dimension extending along the first inner side wall 34a made smaller than a dimension of the recess 26a. The flange 36a is disposed within the recess 26a when the metal part 30 is disposed inside the ceramic part 20. The flanges 36b to 36d are respectively connected to the second inner side wall 34b to the fourth inner side wall 34d, and have a same configuration as that of the flange 36a. Hereafter, when the flanges 36a to 36d do not need to be distinguished from each other, each of the flanges 36a to 36d may be referred to as the “flange 36” without the alphabet index.

In the saggar 10 according to the present embodiment, the metal part 30 has been placed inside the ceramic part 20. That is, the metal part 30 is not adhered to the ceramic part 20. Due to this, the metal part 30 can be removed from the ceramic part 20 simply by lifting the metal part 30. For example, when the saggar 10 can no longer be used due to being broken/damaged, the metal part 30 can be easily removed from the ceramic part 20. The ceramic part 20 is often disposed of when it can no longer be used whereas the metal part 30 is recyclable even when it can no longer be used. Because the metal part 30 can be easily separated from the ceramic part 20, the metal part 30 can be easily recycled when the saggar 10 can no longer be used.

In the saggar 10 according to the present embodiment, the flanges 36 of the metal part 30 are disposed within the recesses 26 of the ceramic part 20. The powder is often collected from the saggar 10 by the saggar 10 being turned upside down after the powder in the saggar 10 has been thermally treated. For example, if the metal part is adhered to the ceramic part, the metal part would not fall even when the saggar is turned upside down. On the other hand, since the metal part 30 is not adhered to the ceramic part 20 in the saggar 10 according to the present embodiment, the metal part 30 will fall when the saggar 10 is turned upside down while only the ceramic part 20 is being held. In the saggar 10 according to the present embodiment, however, the flanges 36 of the metal part 30 are disposed within the recesses 26 of the ceramic part 20. Due to this, if the saggar 10 is held at the position where the flanges 36 are, the saggar 10 can be turned upside down in a state where the metal part 30 is also held together with the ceramic part 20. Due to this, without the metal part 30 being adhered to the ceramic part 20, the metal part 30 can be avoided from falling when the powder in the saggar 10 is being collected. Further, when the flanges 36 project outward more than the ceramic part 20, the saggar 10 may be turned upside down with only the flanges 36 being held. In this case, the ceramic part 20 is supported by the flanges 36 and thus the ceramic part 20 and the metal part 30 can be treated as a unit.

Although in the present embodiment the flanges 36 are defined in each of the first inner side wall 34a to the fourth inner side wall 34d, the disclosure herein is not limited to such feature. For example, the flanges 36 may be defined in two inner side walls 34 facing each other among the four inner side walls 34a to 34d but may not be defined in the other two inner side walls 34. That is, as long as the flanges 36 are defined in the first inner side wall 34a and the third inner side wall 34c, the flanges 36 may not be defined in the second inner side wall 34b and the fourth inner side wall 34d, and as long as the flanges 36 are defined in the second inner side wall 34b and the fourth inner side wall 34d, the flanges 36 may not be defined in the first inner side wall 34a and the third inner side wall 34c. As long as the flanges 36 are defined at least in two inner side walls 34 facing each other, the two flanges 36 defined in the two facing inner side walls 34 can be held together with the ceramic part 20 when the powder in the saggar 10 is being collected. Due to this, as long as the flanges 36 are defined in at least two facing inner side walls 34, the metal part 30 can be avoided from falling when the powder in the saggar 10 is being collected.

The inner bottom surface 32 and the outer bottom surface 22 are both substantially square, and the inner bottom surface 32 is made smaller than the outer bottom surface 22. Due to this, the metal part 30 can be disposed inside the ceramic part 20. Also, when the metal part 30 is disposed inside the ceramic part 20, each of the first inner side wall 34a to the fourth inner side wall 34d is disposed parallel to a corresponding one, that each of the walls 34a to 34d faces, of the first outer side wall 24a to the fourth outer side wall 24d. The saggar 10 may be substantially rectangular in the top view. With the metal part 30 disposed inside the ceramic part 20, a clearance 40 is defined between the outer side wall 24 and the inner side wall 34.

A size of the clearance 40 will be described next. As shown in FIG. 3, two clearances 40a, 40b (hereafter, may be referred to as “pair of clearances 40a, 40b”) are defined between a pair of the outer side walls 24 and a pair of the inner side walls 34 that respectively face each other. For example, the clearance 40a is defined between the first inner side wall 34a and the first outer side wall 24a, and the clearance 40b is defined between the third inner side wall 34c and the third outer side wall 24c. A total of a size d1 of the clearance 40a and a size d2 of the clearance 40b is set so that (d1+d2)>(L1i×b×T)−(L1o×a×T) is satisfied. Here, L1i indicates an outer dimension of the inner side wall 34 (i.e., length from an outer surface of the first inner side wall 34a to an outer surface of the third inner side wall 34c), L1o indicates an inner dimension of the outer side wall 24 (i.e., length from an inner surface of the first outer side wall 24a to an inner surface of the third outer side wall 24c), a indicates a coefficient of thermal expansion of the ceramic constituting the ceramic part 20, b indicates a coefficient of thermal expansion of the metal constituting the metal part 30, and T indicates a maximum temperature during heat treatment of the powder accommodated in the saggar 10.

Further, the clearance 40 (not shown) is defined between another pair of the outer side walls 24 and another pair of the inner side walls 34 that respectively face each other. For example, the clearance 40 is defined also between the second inner side wall 34b and the second outer side wall 24b, and also between the fourth inner side wall 34d and the fourth outer side wall 24d. A total of these clearances 40 is also set so that the total is more than (L2i×b×T)−(L2o×a×T). Here, L2i indicates an outer dimension of the inner side wall 34 (i.e., length from an outer surface of the second inner side wall 34b to an outer surface of the fourth inner side wall 34d) and L2o indicates an inner dimension of the outer side wall 24 (i.e., length from an inner surface of the second outer side wall 24b to an inner surface of the fourth outer side wall 24d).

For example, the saggar 10 according to the present embodiment can be formed as follows. In the ceramic part 20, each side of the outer bottom surface 22 is approximately 330 mm. A thickness of both the outer bottom surface 22 and the outer side wall 24 is approximately 11 mm. Then the inner dimension of the outer side wall 24 (L1o and L2o) makes approximately 308 mm. In the metal part 30, each side of the inner bottom surface 32 is approximately 302 mm. That is, the outer dimension of the inner side wall 34 (L1i and L2i) makes approximately 302 mm. A total of one pair of the clearances 40 (e.g., total of the clearance 40a between the first inner side wall 34a and the first outer side wall 24a and the clearance 40b between the third inner side wall 34c and the third outer side wall 24c) makes approximately 6 mm. Also, the coefficient of thermal expansion of the ceramic constituting the ceramic part 20 is approximately 2.5×10⁻⁶, and the coefficient of thermal expansion of the metal constituting the metal part 30 is 15 to 18×10⁻⁶. The maximum temperature during heat treatment for the powder accommodated in the saggar 10 is approximately 950° C. Due to this, (L1i×b×T)−(L1o×a×T)={302 mm×(15 to 18×10⁻⁶)×950}−(308 mm×2.5×10⁻⁶×950)=3.572 to 4.4327 mm. That is, the total of one pair of the clearances 40 is preferably approximately 4 mm or more (each clearance 40 being approximately 2 mm or more). In the present embodiment, the total of one pair of the clearances 40 is 6 mm and thus the above-described conditional equation is satisfied.

In the saggar 10 according to the present embodiment, the metal part 30 is disposed inside the ceramic part 20. Due to this, with the powder accommodated in the saggar 10, the powder comes into contact with the metal part 30. The metal part 30 has a higher thermal conductivity than the ceramic part 20. Because the powder is in contact with the metal part 30 with the powder accommodated in the saggar 10, the powder can be effectively heated during heat treatment. Also, in the present embodiment, the metal part 30 is constituted of stainless steel and is aluminized. By being aluminized, when the saggar 10 is placed under a heat treatment condition containing oxygen (e.g., when arranged in the heat treatment surface), alumina coating is formed on the surface of the metal part 30. Due to this, the metal part 30 can be suppressed from being oxidized by the powder in the saggar 10 during heat treatment. Here, the metal part 30 may be constituted of a nickel-based alloy containing aluminum.

In the saggar 10 according to the present embodiment, the ceramic part 20 is located at an outer part of the saggar 10. The metal part 30 has a lower durability against a vertical load, whereas the ceramic part 20 has a higher durability against vertical load. Because the ceramic part 20 is located at the outer part of the saggar 10, the plurality of the saggars 10 can be stacked in the up-down direction. Due to this, productivity can be improved in heat treatment.

In the saggar 10 according to the present embodiment, the clearance 40 is defined between the outer side wall 24 and the inner side wall 34. Metal has a higher coefficient of thermal expansion than that of ceramic. Due to this, when the saggar 10 is thermally treated with the powder accommodated in the saggar 10, the metal part 30 expands more than the ceramic part 20 does. Because the metal part 30 is disposed inside the ceramic part 20, if there is no clearance 40 between the outer side wall 24 and the inner side wall 34, the ceramic part 20 may be broken/damaged due to the thermal expansion of the metal part 30. In the present embodiment, by arranging the clearance 40 between the outer side wall 24 and the inner side wall 34, it can be suppressed that the metal part 30 causes excessive thermal stress on the ceramic part 20 even when the metal part 30 expands more than the ceramic part 20 does. Due to this, the ceramic part 20 can be avoided from being damaged/broken due to expansion of the metal part 30.

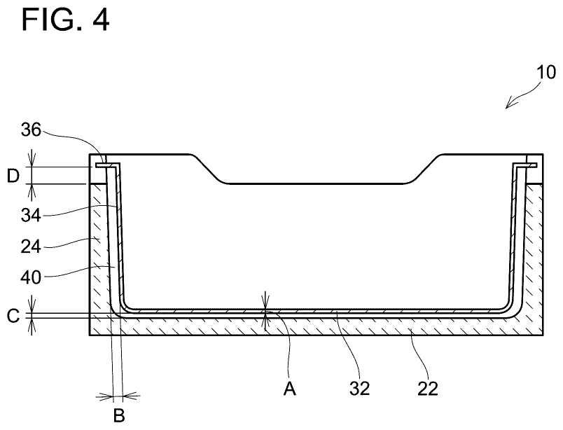

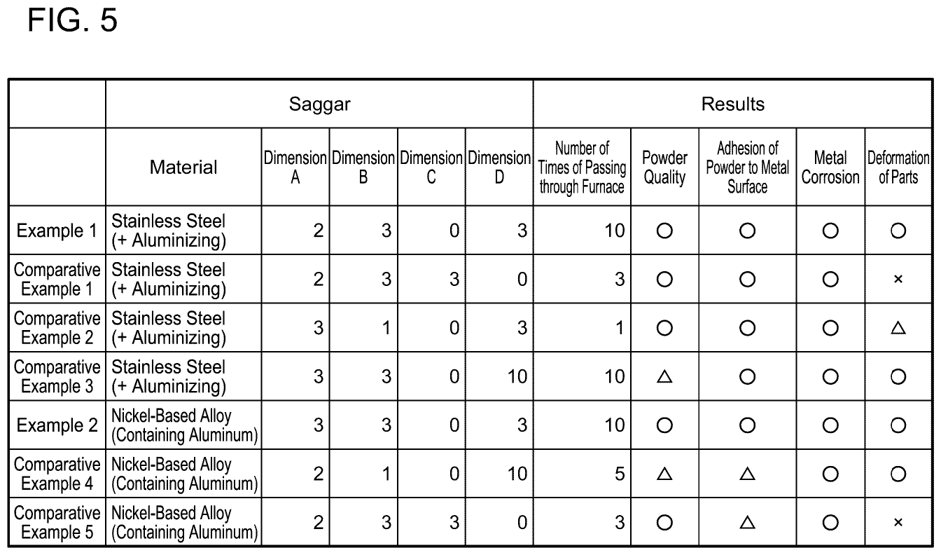

In the present embodiment, it was confirmed that because the saggar 10 has the above-mentioned configuration, the powder in the saggar 10 can suitably be thermally treated. As shown in FIGS. 4 and 5, an experiment was conducted to find out what effects are caused on the saggar and the powder when the powder is thermally treated with the powder accommodated in the saggar 10. In the experiment, an outer diameter of the saggar 10 (outer diameter of the ceramic part 20) was set to approximately 330 mm×330 mm. 7 kg of the positive electrode material (powder) for the lithium-ion battery was placed inside the saggar 10. A plurality of the saggars 10 was then stacked in two vertical tiers in four rows, and was thermally treated through a roller hearth kiln with a length of 42 meters. Conditions of the heat treatment were at an ambient temperature of 950° C. and 96% oxygen atmosphere. The saggars 10 were reused plural times (3 to 10 times) for the heat treatment.

In the saggars 10 according to Example 1, the metal part 30 was constituted of stainless steel and aluminized. A thickness of the metal part 30 (dimension A) was approximately 2 mm. Also, it was confirmed that there was no effect also when the dimension A was approximately 3 mm. Due to this, the thickness of the metal part 30 is preferably approximately 2 to 3 mm, and is more preferably approximately 2 mm in terms of economics. Also, in the saggars 10 according to Example 1, a size of one of the pair of clearances 40a, 40b (distance between the outer side wall 24 and the inner side wall 34, dimension B) was approximately 3 mm. A size between the outer side of the inner bottom surface 32 of the metal part 30 and the inner side of the outer bottom surface 22 of the ceramic part 20 (dimension C) was approximately 0 mm. That is, the inner bottom surface 32 of the metal part 30 was in contact with the outer bottom surface 22 of the ceramic part 20. A length from the lower ends of the recesses 26 to the inner side wall 34 (the flanges 36) (dimension D) was 3 mm.

As shown in FIG. 5, the saggar 10 according to Example 1 yielded high quality powder by the heat treatment despite ten-times use in the heat treatment, and thus the powder could be collected without being adhered to the surface of the metal part 30. Also, there was no corrosion of the metal part 30 nor deformation of respective parts (the ceramic part 20 and the metal part 30). That is, it was confirmed that the saggar 10 according to Example 1 could thermally treat the powder suitably and exhibited high durability against multiple times of reuse.

Example 2 differs from Example 1 in that the metal part 30 is constituted of a nickel-based alloy containing aluminum. In Example 2 as well, the same result as that of Example 1 was obtained, and the powder could be thermally treated suitably and a high durability against a plurality of times of reuse was exhibited.

Comparative examples 1 to 3 show comparative examples of metal parts constituted of a stainless steel and aluminized. A saggar of comparative example 1 differed from the saggar 10 according to Example 1 where the dimension C was 3 mm. That is, in the saggar according to comparative example 1, there was a clearance of approximately 3 mm between the inner bottom surface 32 of the metal part 30 and the outer bottom surface 22 of the ceramic part 20. In other words, in the saggar according to comparative example 1, the metal part 30 was supported by the ceramic part 20 with the flanges 36. In the saggar according to comparative example 1, the metal part 30 was deformed after ten-times of heat treatment due to a weight of the powder accommodated in the metal part 30. Therefore, it was found preferable that the dimension C is 0 mm and the inner bottom surface 32 of the metal part 30 is in contact with the outer bottom surface 22 of the ceramic part 20.

A saggar according to comparative example 2 differed from the saggar 10 of Example 1 in that the dimension B was 1 mm. That is, in the saggar according to comparative example 2, a distance between the outer side wall 24 and the inner side wall 34 was made smaller than that of the saggar 10 of Example 1. In the saggar according to comparative example 2, even after a single time of heat treatment, a ceramic part was pushed by a metal part due to expansion of the metal part, resulting in a crack in the ceramic part. Consequently, it was found that a better result can be obtained when the dimension B is longer than 1 mm, and it is preferable that the dimension B is longer than 2 mm.

A saggar according to comparative example 3 differed from the saggar 10 of Example 1 in that the dimension D was 10 mm. That is, in the saggar according to comparative example 3, an area where the recesses 26 are blocked by the inner side wall was large. Results of ten-times of heat treatment were assessed, and a quality of powder after the heat treatment was problematic. This is presumably because there was failure in ventilation in the saggar owing to the recesses being blocked by the inner side wall. Consequently, it was found that a better result can be obtained when the dimension D is smaller than 10 mm, and it is preferable that the dimension D is approximately 3 mm.

Comparative examples 4 and 5 show comparative examples of metal parts constituted of a nickel-based alloy containing aluminum. Comparative example 4 differed from the saggar 10 of example 2 in that the dimension B is 1 mm. Comparative example 5 differed from the saggar 10 of example 2 in that the dimension C is 3 mm. For comparative examples 4 and 5 also, preferable results were not obtained with respect to the quality of the powder after heat treatment, attachment of the powder on the surface of the metal part, and deformation of the metal part, for example. Given the above, it was confirmed that the powder in the saggar 10 could be thermally treated suitably by using the saggar 10 according to the present embodiment.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A saggar for thermally treating powder of a lithium positive electrode material, the saggar being configured to accommodate the powder and to be disposed in a heat treatment furnace for heat treatment of the powder, the saggar comprising:
a ceramic part constituted of ceramic and having a box shape, the ceramic part comprising an outer bottom surface and an outer side wall projecting upward from the outer bottom surface, the ceramic part being open at its top portion; and
a metal part having a box shape, the metal part comprising an inner bottom surface and an inner side wall projecting upward from the inner bottom surface, the metal part being open at its top portion and being removably disposed inside the ceramic part,
wherein
when the metal part is disposed inside the ceramic part at a room temperature, a clearance is defined between the outer side wall and the inner side wall,
the outer side wall comprises at least a pair of recesses recessed from an upper end toward a lower end of the outer side wall,
in a plan view of the metal part, the pair of recesses is disposed at positions facing each other across a center of the metal part,
the metal part comprises at least a pair of flanges extending outward from an upper end of the inner side wall, and
when the metal part is disposed inside the ceramic part, the pair of flanges is located within the pair of recesses.

2. The saggar according to claim 1, wherein the metal part comprises at least a surface constituted of metal containing aluminum.

3. The saggar according to claim 1, wherein the metal part is constituted of a nickel-based alloy containing aluminum.

4. The saggar according to claim 1, wherein
the ceramic part and the metal part have a rectangular shape in a plan view,
the outer side wall comprises a pair of first outer side walls and a pair of second outer side walls orthogonal to the pair of first outer side walls,
the inner side wall comprises a pair of first inner side walls and a pair of second inner side walls orthogonal to the pair of first inner side walls,
when the metal part is disposed inside the ceramic part, the pair of first outer side walls are parallel to the pair of first inner side walls and the pair of second outer side walls are parallel to the pair of second inner side walls, and
when a coefficient of thermal expansion of the ceramic part is a, a coefficient of thermal expansion of the metal part is b, and a maximum temperature during heat treatment of the powder in the saggar is T,
when an inner dimension between the first outer side walls is L1o and an outer dimension between the first inner side walls is L1i, a clearance defined between the first outer side walls and the first inner side walls is larger than (L1i×b×T)−(L1o×a×T), and
when an inner dimension between the second outer side walls is L2o and an outer dimension between the second inner side walls is L2i, a clearance defined between the second outer side walls and the second inner side walls is larger than (L2i×b×T)−(L2o×a×T).

5. The saggar according to claim 1, wherein when the metal part is disposed inside the ceramic part, the inner bottom surface is in contact with the outer bottom surface.

6. The saggar according to claim 1, wherein when the metal part is disposed inside the ceramic part, upper surfaces of the flanges are located below the upper end of the outer side wall.
